(19) United States
(12) Patent Application Publication
(10) Pub. No.: US 2009/0245520 A1
(43) Pub. Date: Oct. 1, 2009

(54) DIGITAL CONTENT PROTECTION METHODS

(75) Inventors: Andrew C. Chang, Hsinchu City (TW); Ing-Shry Kuo, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/056,316

(22) Filed: Mar. 27, 2008

(51) Int. Cl. G06F 21/24; H04L 9/08

(52) U.S. Cl. 380/279; 713/158; 380/277

(57) ABSTRACT

An digital content protection method and device are disclosed. In the method, digital content to be delivered from a content provider to a consumer terminal is retrieved. The digital content is encoded to prevent unauthorized playback. The encoded digital content and a key for decoding the content are separately transmitted from the content provider to the consumer terminal, playback of the encoded digital content requires decoding with the key.

### BACKGROUND OF THE INVENTION

1. Field of the Invention

The invention relates to computer techniques, and more particularly to data protection.

2. Description of the Related Art

Copy protection of analog data, such as audio or video data recorded on a conventional audio or video magnetic tape cassette wasn't a great issue, because the quality of magnetic tape degrades rapidly when copied from one cassette to another. Digital audio or video data, however can be copied for countless generations without degradation, making digital content protection challenging.

Digital content can be encrypted or compressed to prevent unauthorized duplication. Content providers, however, typically deliver digital content with copy protection with decoding information for decrypting or decompressing the content, which make it easier for hackers to break or work around the protection. Digital content delivered with the decoding information can be copied directly without prior permission from the content provider.

### BRIEF SUMMARY OF THE INVENTION

An exemplary embodiment of a digital content protection method of the invention comprises the following steps. Digital content to be delivered from a content provider to a consumer terminal is retrieved. The digital content is encoded to prevent unauthorized playback. The encoded digital content and a key for decoding the content are separately transmitted from the content provider to the consumer terminal, wherein playback of the encoded digital content requires decoding with the key.

An exemplary embodiment of a digital content protection method is implemented in an electronic device and comprises the following steps. Digital content encoded for playback prevention is retrieved. With the playback prevention, the digital content is not playable until decoded with a key. A decoding key for decoding and making the digital content playable is retrieved. Whether the decoding key has expired is determined. If the decoding key has expired, the digital content is prevented from being decoded with the decoding key. If not, the content is decoded with the decoding key for playback.

An exemplary embodiment of a digital content protection device comprises a first receiver, a second receiver, and a decoder. The first receiver receives digital content encoded for playback prevention by which the digital content is not playable until decoded with a key. The second receiver receives a decoding key for decoding and making the digital content playable. The decoder determines whether the decoding key has expired, if so, the digital content is prevented from being decoded with the decoding key, and if not, content is decoded with the decoding key for playback.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart showing an exemplary embodiment of a digital content protection method;

FIG. 2 is a block diagram showing an exemplary embodiment of a digital content protection system;

FIG. 3 is a schematic view showing exemplary channels between a content provider and a consumer terminal;

FIG. 4 is a flowchart showing delivery of digital content protection and a decoding key;

FIG. 5 is a flowchart showing another exemplary embodiment of a digital content protection method;

FIG. 6 is a schematic view showing exemplary digital content with encoded and not encoded playable portions;

FIG. 7 is a schematic view showing an exemplary embodiment of a consumer terminal;

FIG. 8 is a flowchart showing an exemplary detection of unauthorized access to a decoding key; and

FIG. 9 is a schematic view showing an exemplary embodiment of an electronic device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Digital Content Protection Method

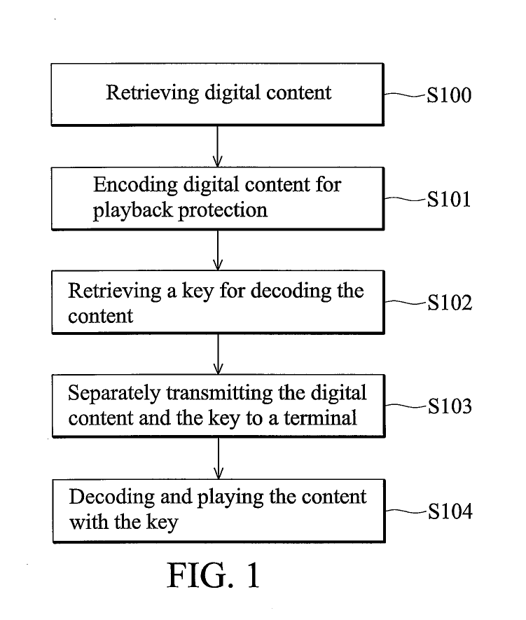

In some embodiments, digital content may comprise text, image, audio, or multimedia data. With reference to FIG. 1, an exemplary embodiment of a digital content protection method is applied to a content provider and a consumer terminal. The content provider retrieves (step S100) and encodes (step S101) digital content to prevent unauthorized playback of the content. Thus, after encoding, digital content is provided with playback protection. For example, the content is encoded such that it can be played only when decoded with a key, hereafter referred to as a decoding key. Techniques of data compression and encryption may be utilized in digital content encoding. The content provider may automatically encode digital content or, in response to a request from the consumer terminal for the content.

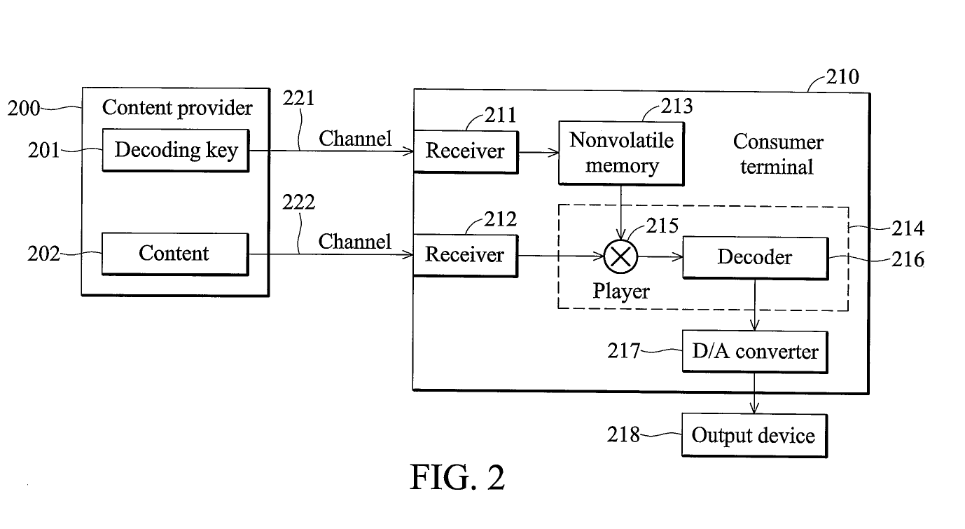

The content provider retrieves a key for decoding the content (step S102) and separately transmits the encoded digital content and the key to the consumer terminal (step S103). The digital content and decoding key can be transmitted through different channels. The channel may comprise different physical communication channels, transportation systems, or business transactions. When receiving the encoded digital content and the key, the consumer terminal decodes and plays the content with the key (step S104). The consumer terminal may comprise a computer, a mobile phone, a smart phone, a personal digital assistant (PDA), a pager, a set top box, a television, a stereo, a portable music player, multimedia player, or others. The content provider may comprise a server computer or a combination of computers and database systems storing digital content and decoding keys. A consumer terminal may serve as a content provider. An exemplary content provider and consumer terminal are shown in FIG. 2.

Exemplary Content Provider and Consumer Terminal

With reference to FIG. 2, content provider 200 comprises decoding key 201 and content 202 respectively to be delivered to consumer terminal 210 through channels 221 and 222. Content 202 has been encoded to prevent unauthorized playback. Digital content after the encoding is provided with playback protection by which the digital content is not playable until decoded with a key. Channels 221 and 222 may be physically separated channels or sub-channels in an identical electronic connection. When receiving decoding key 201, receiver 211 directs decoding key 201 to be stored in non-volatile memory 213. When receiving content 202, receiver 212 makes content 202 retrievable by decoder 215. Content 202 may be stored in terminal 210 after electronically delivered thereto. Decoder 215 retrieves decoding key 201 from non-volatile memory 213 to decode content 202, such that decoder 216 can further receive and play (or decode) decoded content 202 according to the data format of playable data therein. Playable data in content 202 may comprise image data such as conforming to MPEG-4, H.264, or other formats, and/or audio data such as audio data conforming to MPEG-3, .WAV, advanced audio coding (AAC), audio interchange file format (AIFF), or other format. Content decoded by decoder 216 is further converted from digital to analog format by digital-to-analog converter 217, and output by output device 218, such as a display or a speaker. Decoders 215 and 216 can be combined as a player 214. Decoders 215 and 216 may be implemented by circuits or software modules. In some embodiments, output device 218 can be integrated in consumer terminal 210.

When decoding key 201 or content 202 is stored in a storage medium (such as a disc or a flash disk) for delivery, receiver 211 or receiver 212 may comprise a device (such as disc drive or an universal serial bus (USB) controller) for reading the storage medium. Receivers 211 and 212 may comprise a single communication module, such as a network interface card, a cellular MODEM unit, such as a GSM/GPRS or W-CDMA communication module, or others.

At least one component of terminal 210, such as decoder 215 or player 214, may prevent storage, recording, transmission and capture of content decoded by decoder 215, so that for each request to open content 202, content 202 must be decoded with decoding key 201.

With the digital content protection method, digital content and a decoding key are delivered separately to facilitate data security and distribution of the content. Digital content and the key may be separated in transmission time and grouped in different bunches for transmission. Following are exemplary embodiment of separated delivery of digital content and a decoding key.

Delivery Through Different Channels

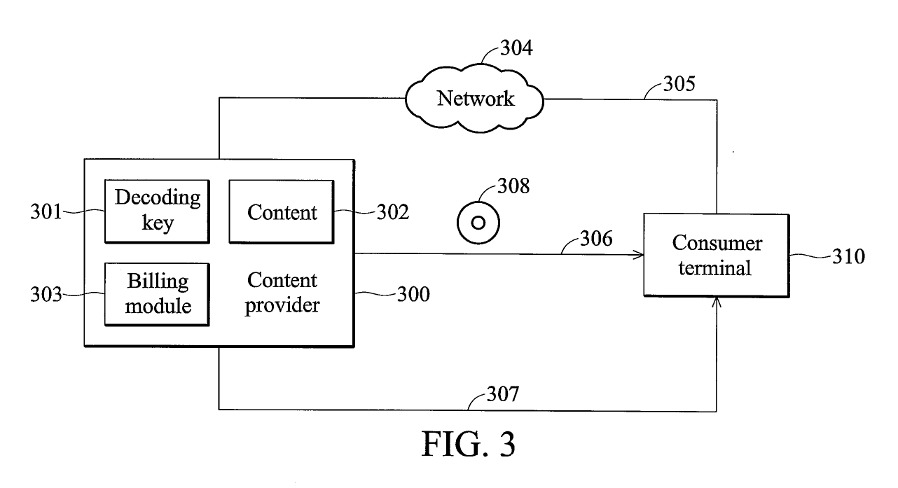

With reference to FIG. 3, content provider 300 and terminal 310 are examples of content provider 200 and consumer terminal 210 respectively. Content 302 has been encoded to prevent unauthorized playback. Channel 305 may be a network connection through network 304, such as the Internet or an intranet. Channel 306 may comprise a distribution system for delivery of storage media 308. Channel 307 may be a wired or wireless telecommunication connection. At least one of content 302 and key 301 may be transmitted in an electronic format or shipped as a package.

When content 302 is stored in storage media 308 and transported through channel 306 to terminal 310, decoding key 301 may be delivered through channel 305 or 307 to terminal 310. Digital content 302 and decoding key 301 may be managed by different e-commerce tools and business policies. For example, content 302 may be provided to terminal 310 without charge while decoding key 301 is provided when terminal 310 passes billing module 303.

Alternatively, when content 302 is delivered through channel 305 to terminal 310, decoding key 301 is transmitted through channel 307 or stored in storage media 308 to be transported through channel 306 to terminal 310. It is appreciated that various types of channels can be utilized to separately deliver digital content and its decoding key. Digital content and its decoding key may be separated in transmission time.

Delivery in Different Time

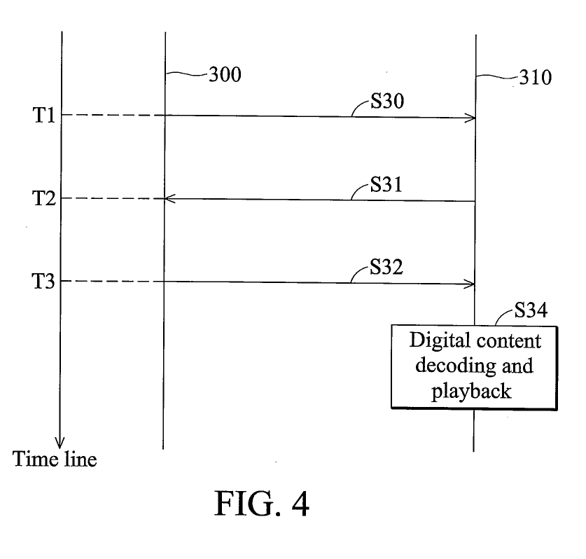

With reference to FIG. 4, content provider 300 transmits content 302 to terminal 310 at time point T1 (step S30). Terminal 310 requests for decoding key 301 at time point T2 (step S31). In response to the request, content provider 300 transmits decoding key 301 to terminal 310 at time point T3 (step S32). Thus, content 302 and decoding key 301 are delivered at different times to facilitate copy protection. Additionally, content 302 and decoding key 301 may be associated with different expiration times defining authorized time limit of using the key for decoding the content, according to legal, key and decoding requirements. When the key time expires, the encoded digital content requires to be decoded with a new key before played.

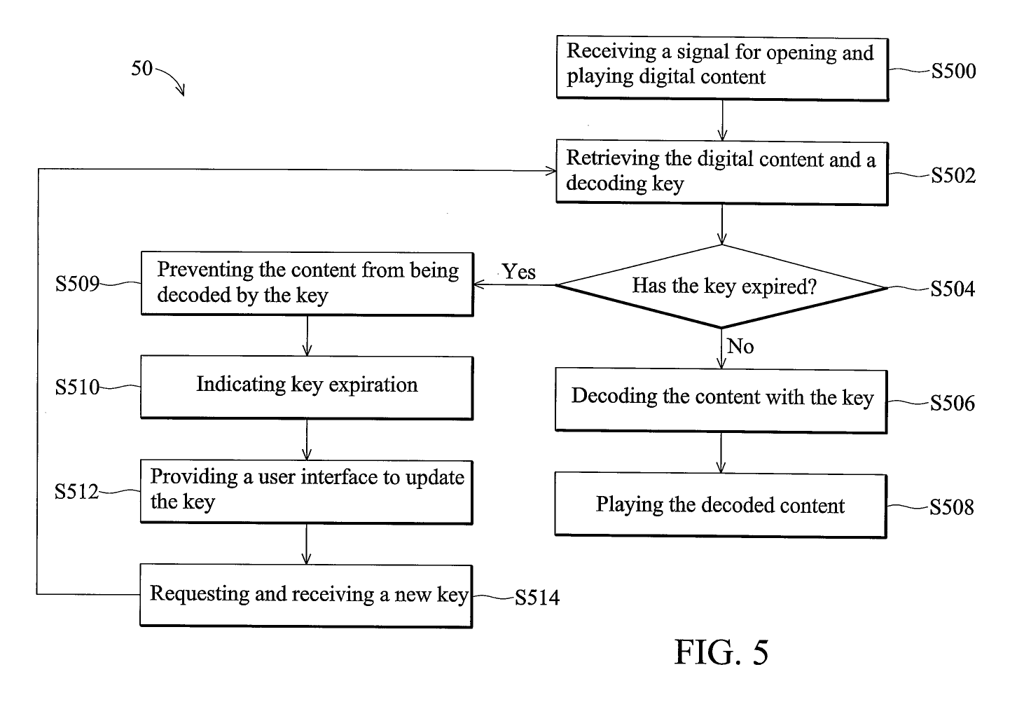

With reference to FIG. 5, decoder 215 retrieves content 302 and decoding key 301 (steps S500 and S502), and determines if decoding key 301 has expired (step S504). If so, step S509 is executed. If not, decoder 215 decodes content 302 with decoding key 301 (step S506) and directs decoded content 302 to be further played (or decoded) by decoder 216 (step S508). Whether the key has expired may be determined based on expiration time of the key, which may comprise the predetermined number of times or a period of time the key can be utilized to decode the content. For determining whether the key has expired, the predetermined number of times can be compared with the current number of times the key has been utilized to decode the content, or the predetermined period of time can be compared with a period of time measured from first use of the key to decode the content.

For example, decoder 215 determines whether decoding key 301 has expired. If not, decoder 215 decodes the content with the decoding key 301 for playback. When decoding key 301 has expired, player 214 prevents the key from decoding content 302 (step S509), presents a message to indicate the expiration and failure to open content 302 (step S510), and provides a user interface to update the key (step S512), by which terminal 310 requests and receives a new key (step S514). In response to expiration of the key, decoder 215 may request a new key for decoding the content 302, and then update the expired key with the new key. Accordingly, decoder 215 retrieves the new key in step S502 and decodes content 302. Decoder 215 further prevents the decoded digital content from being stored in terminal 310 or any storage device, as well as being transmitted to any external device.

Expiration time of digital content and its decoding key may be assigned a maximum number of times the key can be utilized to decode content or a predetermined period of time to be measured from the first use of the key. Expiration time may be integrated in a decoding key. A new key for decoding the content may be requested in response to expiration of the key, and the expired key may be updated with the new key.

Content Encoding

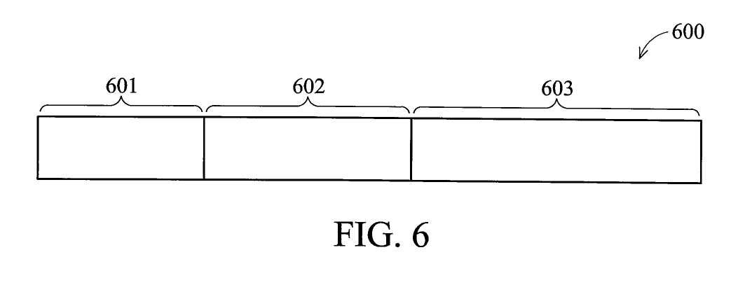

With reference to FIG. 6, playable data of digital content 600 comprises divisions 601˜603. Content 600 may be entirely encoded to prevent unauthorized playback. Techniques of data compression and encryption may be utilized in digital content encoding. For example, digital content is compressed and/or encrypted in encoding step S101 of the method shown in FIG. 1. The key for decoding the content may be a keyword for enabling decompression of the content or a decryption key for decrypting the content.

Content encoding may also be applied to only a portion of the digital content. For example, divisions 601 and 603 are encoded in step S101 while division 602 is not. After the encoding, playable data in digital content 600 is converted into two portions: division 602, the playable portion, which can be directly played to present an excerpt of the playable data of content 600, and divisions 601 and 603, the protected portion, which require decoding with the key to present the remaining playable data. Thus, a consumer terminal may download encoded content 600 to play division 602, for determining whether to further acquire the key for decoding content 600, and when demanded to, requests and receives a key for decoding and playing content 600. Similarly, content encoding may be applied to any portion of content 600.

Key Protection

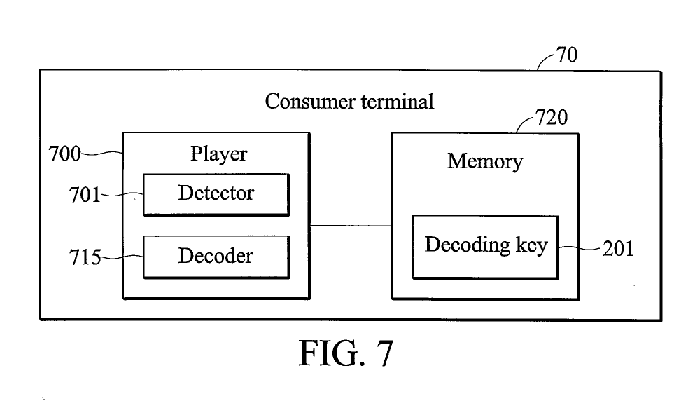

With reference to FIG. 7, consumer terminal 70 is an exemplary embodiment of consumer terminal 210. Player 700 is an exemplary embodiment of player 214 for digital content playback. Decoder 715 is an exemplary embodiment of decoder 215 for disabling the playback protection for one-time playback. Memory 720 is an exemplary embodiment of a non-volatile memory 213 storing decoding key 201. Detector 701 detects and responds to unauthorized access to decoding key 201 in consumer terminal 70.

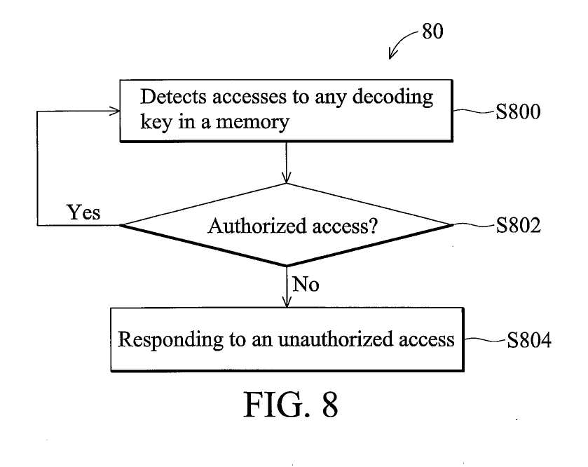

With reference to FIG. 8, detector 701 detects accesses to decoding key 201 in memory 720 (step S800) and determines whether a detected access is authorized (step S802). If so, step S800 is repeated. If not, detector 701 responds to the unauthorized access (step S804). For example, detector 701 identifies who is accessing decoding key 201, determines that the access is authorized when decoder 715 accesses decoding key 201, and determines that the access is unauthorized when another module, such as a file manager, rather than decoder 715 accesses decoding key 201. Detector 701 may prevent update of decoding key 201 for consumer terminal 70 or destroy or delete decoding key 201 in response to an unauthorized access to decoding key 201.

Content provider 300 and terminal 310 may respectively comprise an electronic device. Methods in FIGS. 1, 5, and 8 may be implemented by computer programs which, when loaded to an electronic device, directs the device to execute respective methods. The computer programs may be respectively stored in storage media, such as memory, or storage device. An exemplary embodiment of the electronic device is given in the following.

Hardware Configuration

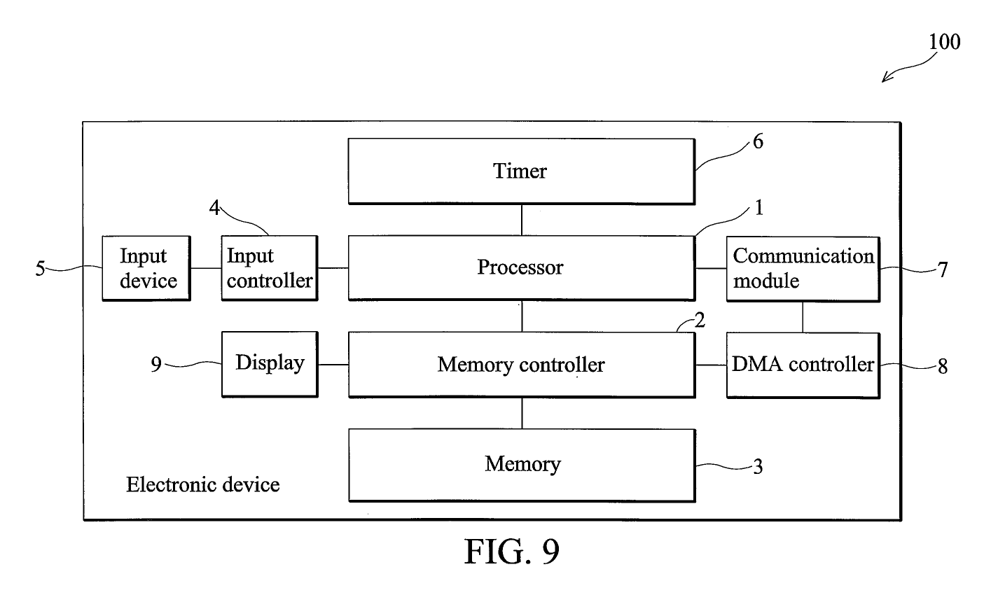

With reference to FIG. 9, electronic device 100 may comprise a mobile phone, a personal digital assistant (PDA), a notebook computer, a tablet personal computer (PC), or any other device capable of executing programs.

In electronic device 100, processor 1 controls operation of the entire system as it fetches and executes software codes stored in memory 3. Memory controller 2 serves as the bridge between processor 1 and memory 3 to transfer data therebetween. Input controller 4 detects states of input device 5 and provides input signals accordingly to processor 1. Input device 5 may comprise a keypad, a touch panel, a touch display, and/or a voice control device by which measurable quantity data may be input. Note that requests for digital content or its decoding key may be triggered via any control interface such as voice commands, a mechanical button on the keypad, a virtual button, drop list, or other graphical user interface (GUI) element shown on display 9.

Timer 6 provides timing information to processor 1, so that processor 1 can determine the times certain events occur, such as transmission and reception of data, and duration, as well as the start or end time of the use of a decoding key. Timer 6 may comprise a plurality of timing devices, such as a clock reporting current time and a timer triggering events or operations. Display 9 may display user interfaces.

Communication module 7 receives and transmits data through a cabled or wireless communication channel. Communication module 7 may comprise infrared, radio frequency (RF), Bluetooth, or other transceiver. Additionally, when a content provider or a consumer terminal is embodied in a mobile phone, communication module 7 can be a cellular MODEM unit, such as a GSM/GPRS or W-CDMA communication module, which communicates with the cellular network in compliance with the Wireless Application Protocol (WAP), GSM/GPRS or W-CDMA standards.

Data outgoing may be prepared and provided by processor 1, or preferably by DMA controller 8 which obtains a data unit from memory 3 through memory controller 2 without intervention of processor 1.

In some embodiments of the electronic device, two or more components (such as processor 1, memory controller 2, memory 3, or DMA controller 6) may be added into a single chip. Some embodiments of the electronic device may comprise only a portion of the elements in FIG. 3 with the others excluded.

### CONCLUSION

With the digital content protection method, digital content and a decoding key are delivered separately and limited to different expiration times, thus facilitating data security and content distribution.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A digital content protection method, comprising:
retrieving digital content to be delivered from a content provider to a consumer terminal;
encoding digital content to prevent unauthorized playback; and
separately transmitting the encoded digital content and a key for decoding the content from the content provider to the consumer terminal, wherein playback of the encoded digital content requires decoding with the key.

2. The method as claimed in claim 1, wherein at least one of the encoded digital content and the key is transmitted in an electronic format or shipped as a package.

3. The method as claimed in claim 2, wherein the encoded digital content and the key are separated in transmission time or grouped in different bunches for transmission.

4. The method as claimed in claim 1, wherein after the encoding, playable data in the digital content is converted into at least two portions, one of which is playable to present an excerpt of the playable data without decoding with the key, and the other requires decoding with the key to present a remaining portion of the playable data.

5. The method as claimed in claim 1, wherein decoding of the encoded digital content is only authorized for a predetermined period of time.

6. The method as claimed in claim 5, wherein when the predetermined period of time has expired, the encoded digital content requires decoding with a new key for playback.

7. The method as claimed in claim 6, further comprising:
detecting unauthorized access to the key in the consumer terminal; and
in response to the unauthorized access to the key, preventing the consumer terminal from retrieving the new key.

8. The method as claimed in claim 1, further comprising:
detecting unauthorized access to the key in the consumer terminal; and
in response to the unauthorized access to the key, destroying the key in the consumer terminal.

9. A digital content protection method, implemented in an electronic device, comprising:
retrieving digital content encoded for playback prevention by which the digital content is not playable until decoded with a key;
retrieving a decoding key for decoding and making the digital content playable;
determining whether the decoding key has expired;
if so, preventing decoding of the digital content with the decoding key; and
if not, decoding the digital content with the decoding key for playback.

10. The method as claimed in claim 9, wherein whether the decoding key has expired is determined based on expiration time of the decoding key, which comprises the number of times the decoding key has been utilized to decode the digital content or a period of time measured from first use of the decoding key to decode the digital content.

11. The method as claimed in claim 9, further comprising:
in response to expiration of the decoding key, requesting a new key for decoding the digital content; and
updating the expired decoding key with the new key.

12. The method as claimed in claim 9, further comprising preventing storage of the decoded digital content.

13. The method as claimed in claim 9, further comprising:
detecting unauthorized access to the decoding key; and
in response to the unauthorized access to the decoding key, preventing the electronic device from retrieving the new key.

14. The method as claimed in claim 9, further comprising:
detecting unauthorized access to the decoding key in the electronic device; and
in response to the unauthorized access to the decoding key, destroying the decoding key in the electronic device.

15. A digital content protection device, comprising:
a first receiver receiving digital content encoded for playback prevention by which the digital content is not playable until decoded with a key;
a second receiver receiving a decoding key for decoding and making the digital content playable; and
a decoder determining whether the decoding key has expired, if so, preventing decoding of the digital content with the decoding key, and if not, decoding the digital content with the decoding key for playback.

16. The device as claimed in claim 15, wherein the decoder determines whether the decoding key has expired based on expiration time of the decoding key, which comprises the number of times the decoding key can be utilized to decode the digital content or a period of time measured from first use of the decoding key to decode the digital content.

17. The device as claimed in claim 15, wherein, in response to expiration of the decoding key, the decoder requests a new key for decoding the digital content and updating the expired decoding key with the new key.

18. The device as claimed in claim 15, wherein the decoder further prevents the decoded digital content from being stored.

19. The device as claimed in claim 15, further comprising:
a detector detecting unauthorized access to the decoding key and in response to the unauthorized access to the decoding key, preventing retrieving a new key.

20. The device as claimed in claim 15, further comprising:
a detector detecting unauthorized access to the decoding key, and in response to the unauthorized access to the decoding key, destroying the decoding key.
